(19) United States
(12) Patent Application Publication
(10) Pub. No.: US 2009/0127367 A1
(43) Pub. Date: May 21, 2009

(54) FISHING REEL

(75) Inventor: Wataru TSUTSUMI, Tokyo (JP)

Correspondence Address: SUGHRUE-265550, 2100 PENNSYLVANIA AVE. NW, WASHINGTON, DC, 20037-3213, US

(73) Assignee: DAIWA SEIKO, INC., Higashikurume-shi (JP)

(21) Appl. No.: 12/274,128

(22) Filed: Nov. 19, 2008

(30) Foreign Application Priority Data
Nov. 19, 2007 (JP) 2007-299582

(51) Int. Cl. A01K 89/033; A01K 89/015

(52) U.S. Cl. 242/286

(57) ABSTRACT

There is provided a fishing reel having a brake system for applying a braking force to a spool which is supported rotatably between side plates of a reel main body and an adjustment member which is supported rotatably on the side plate for adjusting the braking force of the brake system, wherein a control part of the adjustment member is made into a ring form, and a hold part on which a palm can be placed is formed integrally with the side plate inside the ring-formed control part.

### BACKGROUND OF THE INVENTION

The present invention relates to a fishing reel which includes a brake system for imparting a braking force to a spool which is supported rotatably on a reel main body.

Conventionally, in fishing reels, when paying out a fishing line (with terminal tackle) to a predetermined point through a casting operation after a spool has been switched to a free state by controlling a clutch mechanism, in the event that the unwinding or paying-out speed of the fishing line becomes faster than the rotating speed of the spool, since a backlash phenomenon is produced to thereby cause a drawback such as entanglement or biting of the fishing line, it is general practice to equip the fishing reel with a brake system (hereinafter, also referred to as a backlash preventing device) for automatically preventing such a spool overspeeding phenomenon.

Usually, the brake system is configured to apply a braking force to the rotating spool, and, a braking force that is to be applied to a spool is designed to be adjusted by operating to rotate a braking force adjustment member provided on an outside of a side plate of a reel main body. Incidentally, since the braking force adjustment member is provided on a side plate of the reel main body in such a manner as to project therefrom, the braking force adjustment member has a problem that the reel main body tends to have an inferior grip holding property. Then, to solve such a problem, Japanese Patent No. 3955725 proposes a fishing reel in which the whole of an outer surface of a side plate of a reel main body which expands from a central portion to a radially outward circumferential edge portion is made into a control part of a brake force adjustment member, so as to realize an increase in the grip holding property.

In the known technique that has been described above, when the reel main body collides against other things as a result of fall or the like, an external force resulting from the collision is easily applied to the central portion of the outer surface of the side plate which constitutes the control part, and this causes a possibility that a rotational support portion inside the side plate is badly affected or the rotational operating property of the control part is deteriorated by the effect of a mark or scratch that is easily made and left on the outer surface of the side plate as a result of the collision. In addition, separately from this, on an actual fishing occasion, since slime or foreign matters on the palm are easy to adhere to the whole outer surface of the side plate, there is also a possibility that the rotating operation of the control part is deteriorated by those substances.

Furthermore, sine there is no projecting control part on the side plate, although the control part can be grip held by the palm without causing the user to feel a sensation of physical disorder, the control part is easy to rotate unintentionally due to the contact area held by the palm being large when it is held by the palm frequently and repeatedly or grip held in winding the fishing line under high load in an actual fishing scene, and this sometimes leads to a problem that a set value of braking force is changed unintentionally.

### SUMMARY OF THE INVENTION

The invention has been made in view of those problems, and an object thereof is to provide a fishing reel in which the adjustment and setting of braking force applied to the spool can be implemented with no problem while realizing the maintenance of a good grip holding property.

With a view to attaining the object, according to an aspect of the invention, there is provided a fishing reel having a brake system for applying a braking force to a spool which is supported rotatably between side plates of a reel main body and an adjustment member which is supported rotatably on the side plate for adjusting the braking force of the brake system, wherein a control part of the adjustment member is made into a ring form, and a hold part on which a palm can be placed is formed integrally with the side plate inside the ring-formed control part.

According to the configuration described above, the central portion of the side plate constitutes the hold part which is formed integrally with the side plate, and even though the part in question is grip held by the palm, the control part which is position on the periphery of the hold part is affected in no way, thereby making it possible to maintain the good rotational operating property of the control part. In addition, even though the hold part is held by the palm on an actual fishing occasion, since the control part which is position on the periphery of the hold part is affected in no way, a set value of braking force can be maintained in a stable fashion.

According to the aspect of the invention, the fishing reel can be obtained in which the adjustment and setting of braking force applied to the spool can be implemented with no problem while realizing the maintenance of a good grip holding property.

### BRIEF DESCRIPTION OF THE DRAWINGS

FIG. 1 is a diagram showing one embodiment of a fishing reel according to the invention, which is a plan view showing an interior configuration thereof.

FIG. 2 is a diagram showing a main part of the fishing reel shown in FIG. 1.

FIG. 3 is a side view as seen from a left side plate.

FIG. 4 is a diagram showing a first modified example to the embodiment shown in FIG. 1.

FIG. 4 is a diagram showing a second modified example to the embodiment shown in FIG. 1.

### DETAILED DESCRIPTION OF PREFERRED EMBODIMENTS

Hereinafter, referring to the accompanying drawings, an embodiment of a fishing reel according to the invention will be described.

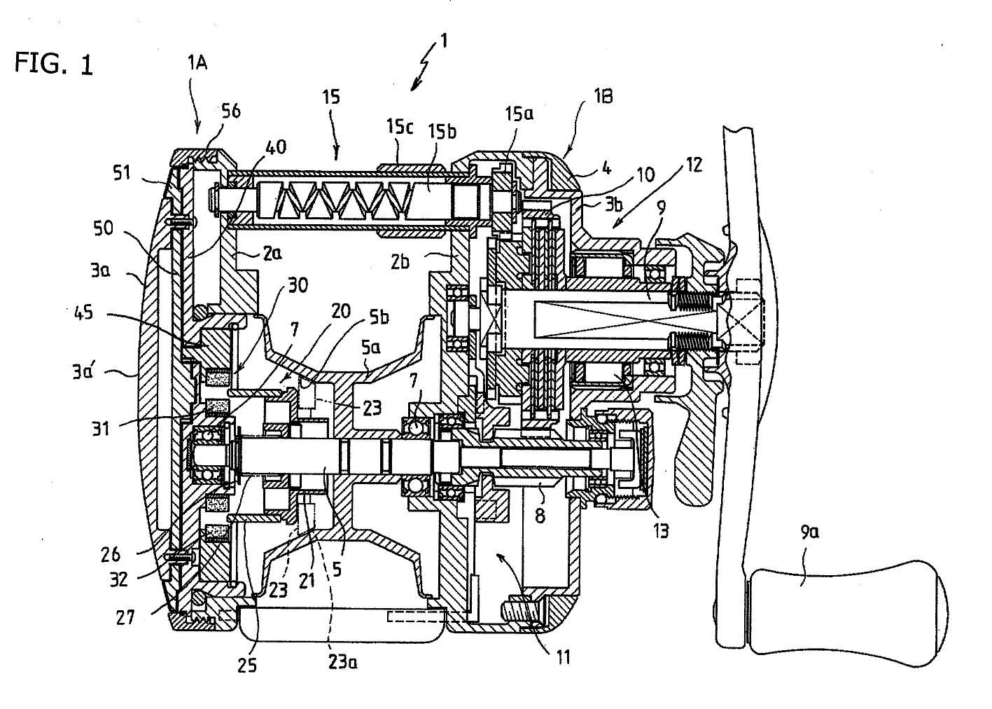

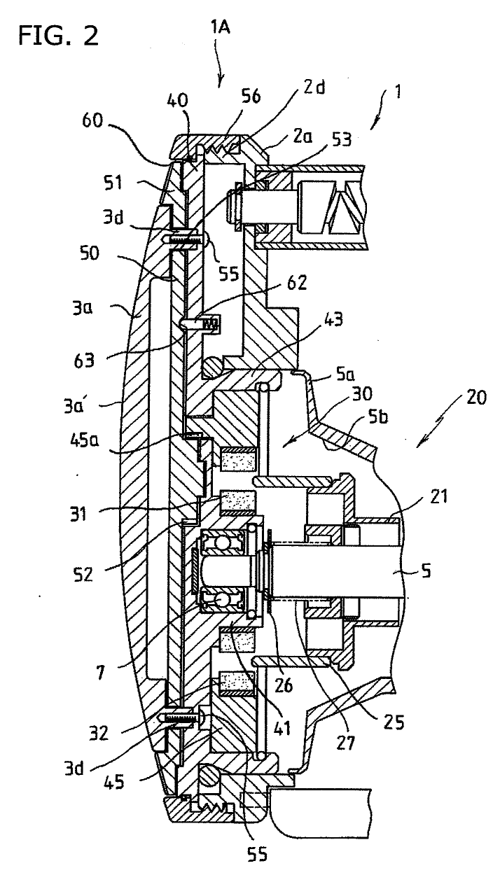

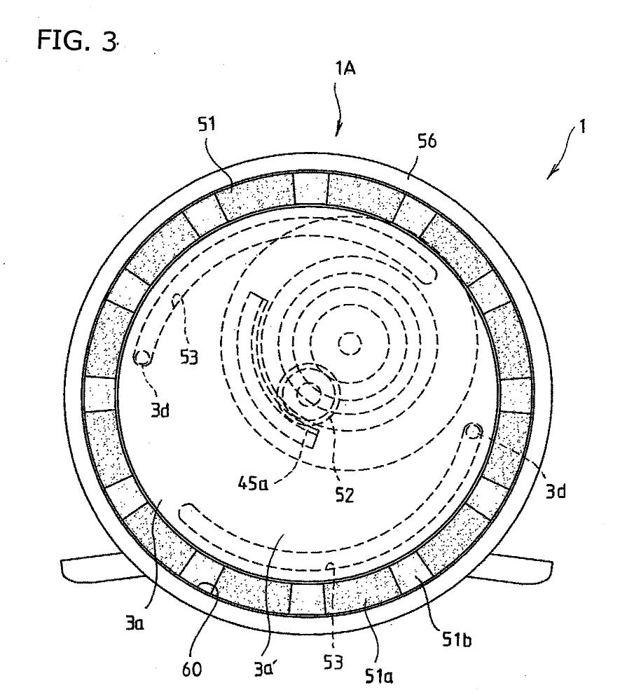

FIGS. 1 to 3 are diagrams showing a first embodiment of a fishing reel according to the invention, of which FIG. 1 is a plan view showing an interior configuration of the fishing reel, FIG. 2 is a diagram showing a main part of the fishing reel shown in FIG. 1, and FIG. 3 is a side view of the fishing reel as viewed from a left side plate side thereof.

A reel main body 1 of the fishing reel (a double-bearing reel) according to this embodiment includes left and right side plates 1A, 1B which include, in turn, left and right frames 2a, 2b and covers 3a, 3b which are attached in such a manner as to cover the left and right frames 2a, 2b, respectively. In this case, the left cover 3a is formed to have a dome shape which smoothly swells outwards in a central area, and a surface of the left cover 3a constitutes a hold part 3a′ which can be held by the palm.

The covers 3a, 3b (the side plates 1A, 1B) are made into a circular shape as viewed from the side and are attached to the frames 2a, 2b, respectively, by fixing means such as machine screws. In addition, a ring-shaped member 4 may be attached to an outer circumferential side of the right cover 3b in such a manner as to conceal the fixing means. Additionally, a ring-shaped member (an annular ring 56) is attached to an outer circumferential side of the left cover 3a so that a set plate, which will be described later, is fixed to the left frame 2a.

A spool shaft 5 is supported rotatably between the left and right side plates 1A, 1B via bearings 7, and a spool 5a on which a fishing line is wound is fixed integrally to the spool shaft 5. In addition, a pinion gear 8 is attached to an end portion of the spool shaft 5 which projects from the right frame 2b in such a manner as to shift along an axial direction of the spool shaft 5. This pinion gear 8 is made to shift by a known clutch mechanism 11 between an engagement position (a power transmitting state) where the pinion gear 8 is brought into engagement with the spool shaft 5 for rotation together with the spool shaft 5 and a disengagement position (a power cut-off state) where the pinion gear 8 is disengaged from the spool shaft 5. In addition, a drive gear 10 supported on a handle shaft 9 is brought into mesh engagement with the pinion gear 8, whereby the spool shaft 5 is driven to rotate via the drive gear 10 and the pinion gear 8 by operating to rotate a handle 9a attached to an end portion of the handle shaft 9, and the spool 5a rotates as the spool shaft 5 so rotates.

A known drag mechanism 12 is installed between the handle shaft 9 and the drive gear 10, so that a desired braking force can be applied to the spool 5a as when the fishing line is unwound by a fish which has taken the bait and hook. In addition, a one-way clutch 13 is installed between the handle shaft 9 and the right cover 3b, and this one-way clutch 13 is made to cause the handle shaft 9 to rotate only in a direction in which the fishing line is wound.

Furthermore, a level winding mechanism 15 is installed on a front side of the spool 5a between the left and right side plates 1A, 1B. As is known, this level winding mechanism 15 includes an interlocking gearwheel 15a which meshes with the drive gear 10, a screw shaft 15b which rotates together with the interlocking gearwheel 15a and a fishing line guide element 15c which is brought into engagement with the screw shaft 15b, whereby by operating to rotate the handle 9a, the screw shaft 15b is caused to rotate, so as to cause the fishing line guide element 15c to reciprocate in horizontal directions.

According to the configuration that has been described heretofore, by operating the handle 9a for winding up the fishing line, the spool 5a is driven to rotate via the drive gear 10 and the pinion gear 8, while the fishing line guide element 15c is caused to reciprocate in the horizontal directions by the level winding mechanism 15, whereby the fishing line is wound on the spool 5a uniformly.

In addition, a brake system 20 is provided on a left side plate 1A side of the reel main body 1 for preventing the overspeeding of the spool 5a when a fishing line paying-out operation (mainly a casting operation) is implemented with the clutch mechanism put in an OFF state. Hereinafter, the configuration and function of the brake system 20 will be described.

The brake system 20 of this embodiment is configured in such a manner as to apply a braking force to the spool 5a by means of a magnet and has a shift element 21 which is fitted on the spool shaft 5 in such a manner as to be able to shift along the axial direction thereof but as not to rotate thereon and centrifugal collars 23 which are held on an outer circumferential surface of the shift element 21 at predetermined intervals in such a manner as to shift in a radial direction. These centrifugal collars 23 are made to be shifted radially outwards by virtue of centrifugal force when the spool shaft 5 (and the shift element 21) rotates together with the spool 5a.

In addition, an annular conductive element 25 is supported on a left side plate side of the shift element 21. This conductive element 25 is made to shift in the axial direction relative to the spool shaft 5 as the shift element 21 shifts. In addition, a tapered surface 5b is formed on a rear surface side of a fishing line winding surface of the spool 5a in such a manner as to be expanded diametrically step by step towards the left frame 2a side. This tapered surface 5b is made to be brought into surface contact (engagement) with inclined surfaces 23a formed on outer surfaces of the centrifugal collars 23 when the centrifugal collars 23 shift radially outwards so as to guide the shifting centrifugal collars 23. Namely, the centrifugal collars 23 which are supported on the shift element 21 are made to shift radially while being guided along the tapered surface 5 through an engaging action between the inclined surfaces 23a and the tapered surface 5b by virtue of centrifugal force generated in association with rotation of the spool shaft 5 (the spool 5a), whereby the shift element 21 on which the annular conductive element 25 is supported is made to shift in the axial direction towards the left frame 2a side along the spool shaft.

In addition, a spring member 27 is fitted on the spool shaft 5 in such a manner as to be interposed between a retainer 26 fixed to one end portion of the spool shaft 5 and the shift element 21 so that the shift element 21 is normally biased in a direction towards the spool 5a side (the conductive element 25 is normally biased towards the spool 5a side or in a direction in which the conductive element 25 moves away from a magnetic field of a magnet, which will be described later).

Furthermore, the brake system 20 is provided on the left side plate 1A side of the reel main body 1 or closer to the left side plate 1A and includes a magnet 30 which generates a magnetic force which acts between the conductive element 25 adapted to shift in the axial direction and itself. This magnet 30 is made to apply a magnetic force to the conductive element 25 which shifts backwards and forwards in the axial direction in association with rotation of the spool 5a, so as to apply a braking force to the conductive element 25. In this embodiment, the magnet 30 includes an internal magnet 31 which is made into an annular shape and is provided on an inner surface side of the conductive element 25 in such a manner as to confront with a predetermined interval provided therebetween and an external magnet 32 which is made into an annular shape and is provided on an outer surface side of the conductive element 25 with a predetermined interval provided therebetween. By this configuration, the conductive element 25 is allowed to move into and out of a magnetic field generated in a gap defined between the internal magnet 31 and the external magnet 32, exerting a magnetic braking force on the spool 5a.

The magnet 30 which makes up the brake system is attached to a set plate 40 which is installed between the left frame 3a and the left cover 3a. An internal annular wall 41 is formed in a central area of the set plate 40 in such a manner as to project towards the spool side, and the bearing 7 is disposed inside this annular wall 41 so as to support rotatably one end of the spool shaft 5, and the internal magnet 31 is attached to an outside of the annular wall 41.

In addition, an external annular wall 43 is formed on the set plate 40 radially outwards of the internal annular wall 41. This external annular wall 43 is press fitted in an opening in the left frame 2a, and a holder 45 to which the external magnet is attached is installed rotatably inside the external annular wall 43. Internal teeth 45a, which are made to mesh with a gearwheel 52 formed on an adjustment member 50 which will be described later, are formed integrally on a left cover side of the holder 45. In addition, the internal teeth 45 are formed in a circular arc-like shape as is shown in FIG. 3 because the internal teeth 45 are configured in such a manner as to displace the holder 45, that is, the external magnet 32 in a circumferential direction within a predetermined angular range so as to change polarities between the internal magnet 31 and the external magnet 32 to thereby adjust the magnetic braking force applied to the conductive element 25 which shifts backwards and forwards between both the magnets.

The adjustment member 50 for adjusting a braking force applied to the spool is installed between the set plate 40 and the left cover 3a. This adjustment member 50 is a member which displaces the external magnet 32 attached to the holder 45 in the circumferential direction so as to change polarities between the internal magnet 31 and the external magnet 32 to thereby adjust the braking force and is formed into a circular disk shape, and a control part 51 made into a ring form is formed on the adjustment member 50 on a radially external side thereof. In addition, the gearwheel 52 is formed in a central portion thereof in such a manner as to mesh with the internal teeth 45a formed on the holder 45 (a separate gearwheel may be attached)

In this case, the set plate 40 is made integral with the left cover 3a by screwing from an inside machine screws 55 into machine screw retaining portions 3d (formed in two locations) which are provided in such a manner as to project into an inside of the left cover 3a and is also applied to an annular wall 2d formed on the left frame 2a at an outer circumferential portion thereof, whereby by attaching the annular ring 56, the set frame 40 is made integral with the left frame 2a. Namely, the left cover 3a and the set plate 40 are fixedly integrated with the left frame 2a.

In addition, the left cover 3a (the left side plate 1A) is configured in such a manner that an annular recess 60 is formed between the annular ring 56 and itself in a position lying radially outwards of the hold part 3a′, and the control part 51 of the adjustment member 50 is disposed within this annular recess 60 in such a manner as to rotate within the predetermined angular range. Because of this, as is shown in FIG. 3, a circular arc-like hole 53 is formed on the adjustment member so that the control part 51 can rotate along the machine screw retaining portions 3d provided on the left cover 3a in such a manner as to project therefrom. By this configuration, in the adjustment member 50, the ring-formed control part 51 is exposed at the portion where the annular recess 60 is formed, and the other portions thereof are closed by the left cover 3a (the hold part 3a′).

In addition, a roughening treatment is preferably applied to a surface of the control part 51 which is exposed at the portion lying radially outwards of the hold part 3a′ in the way described above. In this embodiment, recessed portions 51a and raised portions 51b are formed continuously along a circumferential direction, so that when the fingers are applied to the control part 51, the fingers are easily caught on the raised portions 51b for easy rotation of the control part 51. Of course, in addition to the application of recessed and raised portions like those described above, the surface of the control part 51 can be deformed appropriately by applying a sand blasting treatment, attaching a highly frictional member or the like.

In addition, the adjustment member 50 is configured in such a manner that a sensation of clicking (a generation of clicking sound) is made to be felt by the user when he or she operates to rotate the control part 51 by applying a resisting force to the rotation. Specifically, a click member 62 is supported elastically on a left cover side surface of the set plate 40, while a recess 63 is formed on a left frame side surface of the adjustment member 50 in such a manner as to continue in a circular arc-like fashion, so that the sensation of clicking is given to the user when he or she operates to rotate the adjustment member 50. Note that a configuration maybe adopted in which such a clicking mechanism is not installed for applying the sensation of clicking to the adjustment member 50 when it is rotated.

In addition, when adjusting a braking force applied to the spool 5a, the finger or fingers are applied to the control part 51 of the adjustment member 50 to operate to rotate the control part 51, whereby the holder 45 to which the external magnet 32 of the brake system 20 is caused to rotate via the gearwheel 52 of the adjustment member 50 and the internal teeth 45a of the holder 45. This displaces the external magnet 32 in the circumferential direction and polarities are changed between the internal magnet 31 and the external magnet 32, whereby a magnetic braking force being applied to the conductive element 25 which shifts backwards and forwards between both the magnets is adjusted.

According to the fishing reel configured in the way described above, since the control part of the adjustment member 50 which is operated to rotate is not disposed in the central area of the side plate 1A which swells outwards, even though the reel main body is dropped or an external force is applied thereto, the control part 51 residing radially outwards of the adjustment member 50 is affected in no way, and hence, there occurs no situation in which the rotational operating property of the control part 51 is deteriorated. In addition, on an actual fishing occasion, even though slime or foreign matters on the palm are caused to adhere to the outer surface of the side plate 1A (the left cover 3a), the deterioration in rotational operating property of the control part 51 due to the slime or foreign matters is suppressed. Furthermore, since no projecting control part such as a knob exists on the side plate 1A, the adjustment member 50 can be grip held by the palm without causing the user to feel the sensation of physical disorder, and even though the adjustment member 50 is held by the palm frequently and repeatedly or is grip held in winding the fishing line under high load in an actual fishing scene, it will never happen that the control part 51 is caused to rotate abruptly or unintentionally and that the set value of braking force is changed unintentionally.

In addition, as has been described above, by the ring-formed control part 51 being installed in the position of the annular recess 60 which is formed on the external side of the hold part 3a′, the surface of the control part 51 can be disposed substantially level with the surface of the hold part 3a′ and the surface of the annular ring 56. By this configuration, a further increase in the grip holding property can be realized, and the external appearance of the fishing reel can be enhanced.

Thus, while the embodiment of the invention has been described heretofore, the invention is not limited to the embodiment and hence, can be modified variously.

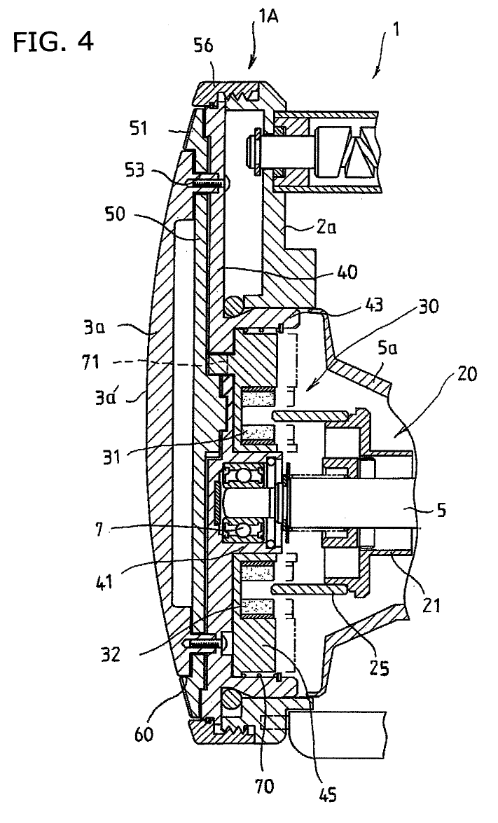

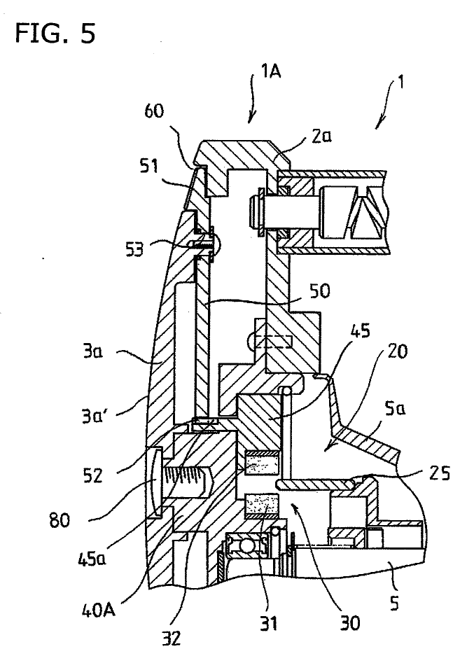

In the embodiment, while the brake system 20 is configured in such a manner that the magnetic braking force being applied to the conductive element 25 which shifts backwards and forwards between the internal magnet 31 and the external magnet 32 is adjusted by displacing the external magnet 32 in the circumferential direction, as is shown in FIG. 4, a configuration may be adopted in which the internal magnet 31 and the external magnet 32 are supported on the holder 45 in advance, so that the axial position of both the magnets relative to the conductive element 25 is changed. Namely, the holder 45 is biased towards the left cover side relative to the external annular wall 43 of the set plate 40 via a biasing spring 70, and a cam surface 71 is formed on a portion of the holder 45 which confronts the adjustment member 50. In addition, an abutment portion which is normally in abutment with the cam surface 71 is formed on the adjustment member, whereby when the adjustment member 50 is caused to rotate by the control part 51, the holder 45 is displaced to the spool side against the biasing force of the biasing spring member 70 by the cam surface 71.

As a result of this, the axial position of the internal magnet 31 and the external magnet 32 relative to the conductive element 25 can be changed, to thereby adjust the braking force.

In this way, the brake system 20 can be modified as required. Alternatively, in addition to the magnetic brake system which makes use of the magnets, other configurations may be adopted which includes a centrifugal brake system and the like.

In addition, the configuration of the side plate 1A on which the adjustment member 50 is installed, specifically speaking, the layout mode and shapes of the frames, covers, and the set plate can be modified as required. In the embodiment that has been described above, while the set plate 40 is retained on the left cover 3a from the rear side with the machine screws and the adjustment member 50 is installed between the set plate and the left cover, as is shown in FIG. 5, the left cover 3a is fixed to a set plate 40A from the outside with a screw 80, so that the adjustment member 50 may be attached rotatably direct to the left cover 3a without interposing the set plate therebetween. In addition, a configuration may be adopted in which the annular ring 56 shown in FIG. 2 is not attached or provided. In a configuration like this, the annular recess 60 can be formed between the left cover 3a and the left frame 2a.

In this way, the configuration of the side plate on which the adjustment member 50 is disposed can be modified as required, and in addition to the configurations of the side plate 1A described above, a configuration may be adopted in which the side plate 1A is integrated with the left frame 2a. Namely, as to the hold part 3a′ on the side plate which is held by the palm, the hold part may only have to be integrated with a member which makes up the side plate 1A, and hence, a configuration may be adopted in which the hold part 3a′ is integrated with the left frame 2a. In addition, the hold part 3a′ is a portion on which the palm is placed, and the control part may only have to be positioned outside thereof. In addition, the hold part 3a′ may take other external shapes than the outwardly swelling dome shape, and hence, the hold part 3a′ may be made up of, for example, a flat surface or an irregular surface.

What is claimed is:

1. A fishing reel comprising:
a reel main body including side plates;
a spool supported rotatably between the side plates;
a brake system for applying a braking force to the spool;
an adjustment member including a control part which is made into a ring form and is supported rotatably on one of the side plates for adjusting the braking force of the brake system; and
a hold part on which a palm of a user can be placed and which is formed integrally with the one of the side plates inside the control part.

2. The fishing reel according to claim 1, wherein an annular recess is formed outwards of the hold part on the side plate, and the control part is installed rotatably within the annular recess.

3. The fishing reel according to claim 1, wherein a roughening treatment is applied to a surface of the control part.
